(19) United States
(12) Patent Application Publication
(10) Pub. No.: US 2020/0045419 A1
(43) Pub. Date: Feb. 6, 2020

(54) STEREO UNFOLD TECHNOLOGY

(71) Applicant: Omnio Sound Limited, Dorking (GB)

(72) Inventor: Bernt BÖHMER, BJÄRRED (SE)

(21) Appl. No.: 16/338,664

(22) PCT Filed: Oct. 4, 2017
(86) PCT No.: PCT/SE2017/050971

§ 371 Date: May 3, 2019

(30) Foreign Application Priority Data
Oct. 4, 2016 (SE) 1651301-2

(51) Int. Cl. H04R 3/12; H04S 7/00; H04R 5/02

(52) U.S. Cl. CPC H04R 3/12; H04S 2400/15; H04R 5/02; H04S 7/306

(57) ABSTRACT

The Stereo Unfold Technology solves the inherent problems in the stereo reproduction by utilizing modern DSP technology to extract information from the Left (L) and Right (R) stereo channels to create a number of new channels that feeds into processing algorithms. The Stereo Unfold Technology operates by sending the ordinary stereo information in the customary way towards the listener to establish the perceived location of performers in the sound field with great accuracy and then projects delayed and frequency shaped extracted signals forward as well as in other directions to provide additional psychoacoustically based clues to the ear and brain. The additional clues generate the sensation of increased detail and transparency as well as establishing the three dimensional properties of the sound sources and the acoustic environment in which they are performing. Moreover, also enhanced grouping as described is one aspect possible to implement according to the present invention.

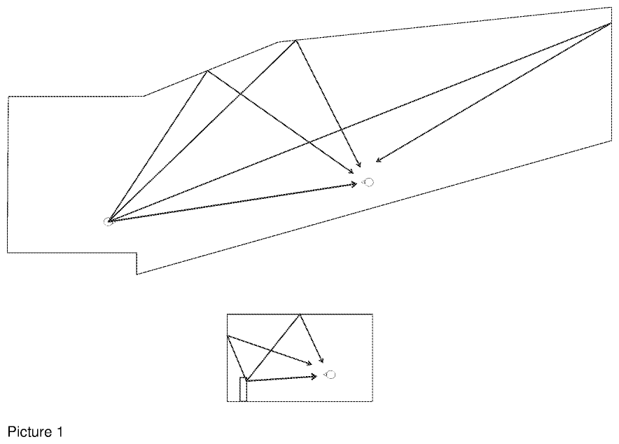

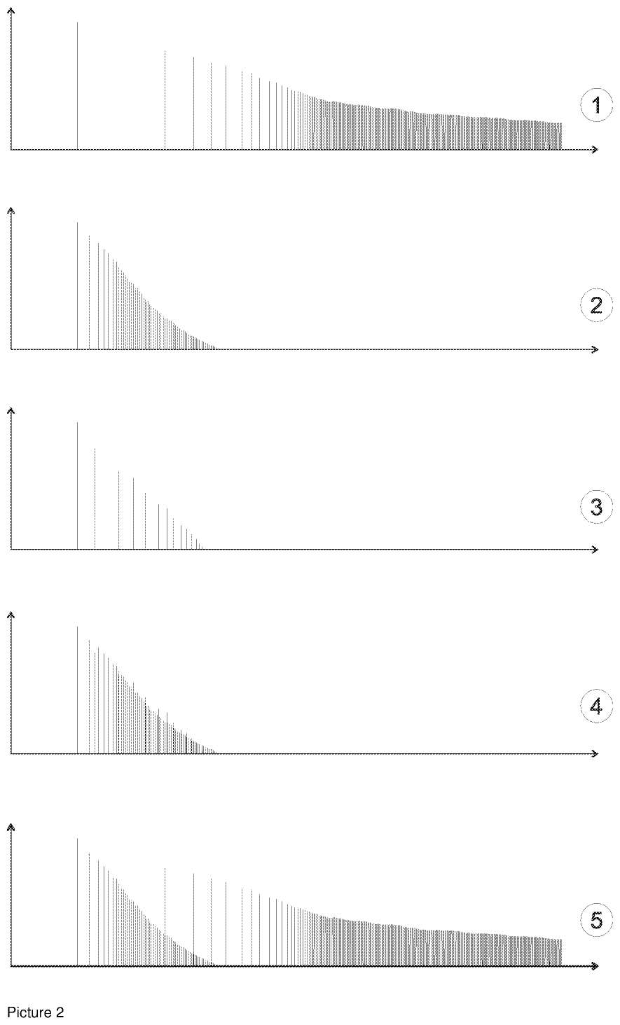

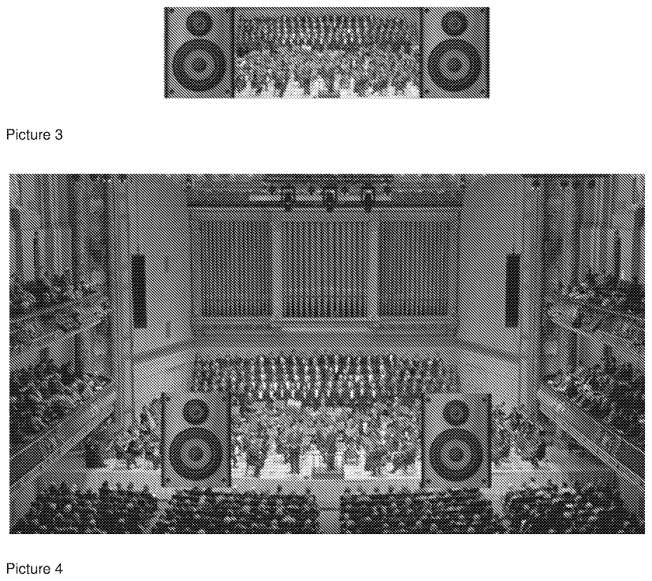

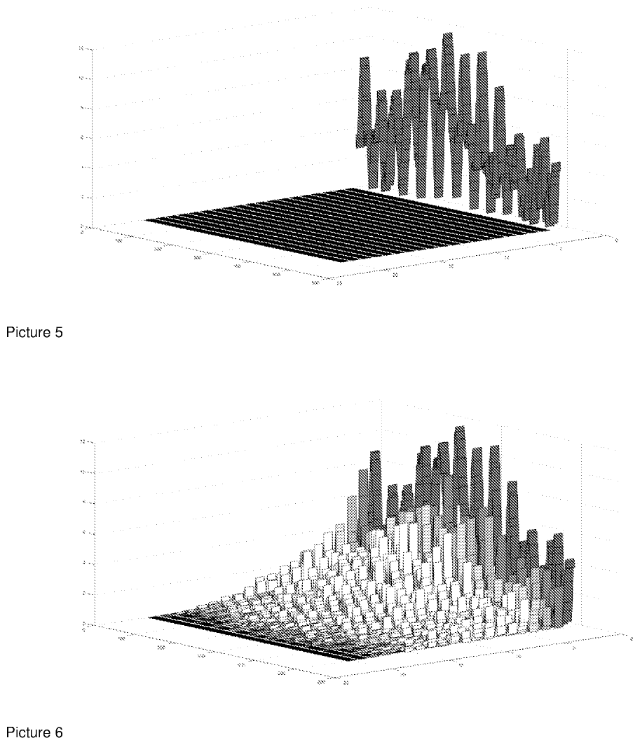

### INTRODUCTION

What we commonly consider as the modern stereophonic technology for recording and reproduction of sound was actually invented already in 1931 by Alan Blumlein and the well-known principles behind stereo have not changed in almost a hundred years. On the recording side numerous variations on microphone placement and combinations of microphones with different pickup patterns have been tried. More or less all imaginable variants have been tested and a few particularly successful configurations have gained popularity due to unusually good results. The original Blumlein angled pair of figure eight microphones is one of these good configurations and it is still frequently used today. Similarly, many different types of loudspeaker configurations have been tested for stereophonic reproduction but also in this case the original Blumlein ideas are still employed without significant changes.

It is hard to imagine any other field of science that has remained as static without any noticeable changes to its principles. In many modern products and practices the availability of small computers has completely changed the ways they operate and significantly expanded their performance envelop. Still, stereo remains the same with no changes.

There are two separate target segments within the stereophonic technology where improvements can be applied, recoding and/or reproduction. We already have a legacy of more than half a century of high quality stereophonic recordings and we have a whole industry tied up to a particular way of recording, storing and distributing music. Obviously any changes on the recoding side would face tremendous hurdles before it could be employed and become widely distributed to music listeners. On the other hand, improvements to the reproduction, if it uses ordinarily recorded music, faces no such obstacles and could be used by anyone that desires an improvement.

The Stereo Unfold Technology targets stereophonic reproduction and significantly improves the listening experience making it more lifelike and believable. Our stereo recordings are missing all spatial information apart from some left to right localization clues. The stereo speakers and the listening room work together to create the sensation of a three-dimensional sound stage in front of us but this is just an illusion created by the speakers and the listening room together, it is not something that is encoded in the stereo recording. Traditional loudspeakers scale the size of the sound stage and the instruments therein to their own size.

It still only needs two speakers for highest-quality operation, not multiple speakers spread around the room like in multichannel audio. It also makes small speakers sound like large speakers; the size of the sound stage is no longer tied to the size of the speaker. Before, a small speaker always sounded like a small speaker, projecting a smaller image of the sound stage than a large speaker would.

The Stereo Unfold Technology creates a three-dimensional soundstage populated with three-dimensional sound sources generating sound in a continuous real sounding acoustic environment that is interpretable by the human brain. In one of its implementations the Stereo Unfold Technology also works using headphones as reproduction devices.

Stereo Unfold and Prior Art

As expected there's an abundance of prior art in the audio DSP field that sets out to solve various issues present in sound reproduction. All of them use the same fundamental DSP building blocks like IIR filters, FIR filters, delays, Left minus Right extraction algorithms etc. but with different end results. Looking at prior art it becomes apparent that there are three major groups within the field that can be considered somewhat related to the Stereo Unfold Technology.

First there is prior art that outlines methods for achieving a wider stereo image. Those are predominantly focused on stereo speakers that have the left and right speaker located physically close together even possibly in a single enclosure. These all aim to widen the stereo image and mitigate the problems that arise with closely spaced stereo speakers.

Secondly there is another group of patent documents around what's called sound bars, i.e. a one box speaker positioned front center that replaces multiple surround speakers spread around in the listening room in a surround sound system. Within this group the aim is to give the listener the sensation of being within a surround sound field normally created using several speakers in front and at the back of a room. The sound bars utilize various techniques with drivers aimed in different directions together with DSP algorithms to create a surround sound experience.

In relation to the above explanations it may be mentioned that for instance the documents US2015/0189439 and US2015/0071451 both refer to this first and second group.

Thirdly there's an in general somewhat older group of prior art that aims to improve the stereo experience by aiming basically Left minus Right derived contents in other directions than forward. Since done before the DSP technology became readily available and cost effective the processing used is very basic and limited to what was possible at the time. The available technology severely reduced the realizable sound quality and since the results were mostly disappointing it seems that work within this group has come to an end.

The first group deals with the technical problem of having two speakers closely spaced and tries to achieve a result similar to having widely spaced stereo speakers. The second group tries to replicate a surround sound field in the listening room using only one speaker instead of several. The third group tries to improve the perceived ambiance when listening to stereo but is unsuccessful due to inadequate processing and does not address the psychoacoustic problems inherent to stereo. None of the above prior art groups deal with the general shortcomings of stereo, why stereo as a method is flawed and how the stereo technique can be improved. The Stereo Unfold Technology aims to solve these inherent problems within the stereo technique.

The Stereo Unfold Technology recreates a continuous spatial 3D sound field that is similar to a real acoustic event. Ordinary stereo reproduction can at best project a sound stage but the sound sources within that soundstage sound like they are paper cutouts of performers without any individual extension in depth and the paper cutouts perform in solitude without being in an acoustic space, much like flashlights suspended in a black room. The Stereo Unfold Technology creates a spatial 3D sound field but it is not at all the same experience as listening to a surround sound system. A surround sound system is at its core an extension of stereo with the same limitations as stereo. With the use of additional speakers located around the room it can create position information not only from the front between the left and right speakers but also other locations around in the room. Stereo Unfold have specifically been achieved through understanding of the psychoacoustic grouping phenomenon and the spatial sound processing in the human brain, it is an entirely different method and the result is a spatial 3D sound field that is audibly like a live acoustic event.

Mono & Stereo

At first, sound was recorded and played back in mono. The mono process can at best provide some perceived depth and height of the soundstage projected in front of the listener but it is basically unable to convey any localization clues for the individual sound sources in the recording. The limited soundstage that is available is created by reflections from surfaces in the listening room. The reflections create an illusion of a cloud of sound around the single loudspeaker source. This can easily be verified by listening to mono in an anechoic environment where the cloud disappears.

In 1931 Alan Blumlein invented he stereo process. Stereo was an unfolded version of mono, unfolded in the physical horizontal plane by the use of two loudspeakers. It allowed localization of sound sources horizontally anywhere between the loudspeakers. When stereo is properly recorded and played back on loudspeakers it manages to create a relatively continuous horizontal plane of sound in front of the listener with some height and depth present. The listener's brain is fooled by the process into believing that there are multiple sound sources in front of him/her despite the fact that all sound only emanates from two speakers. Stereo played back through loudspeakers makes use of psychoacoustics to create an illusion of a soundstage populated by multiple sound sources at different horizontal locations in front of the listener. As with mono, reflected sound from the loudspeakers, reflected by the surfaces within the listening room, creates the illusion of a soundstage in front of the listener, i.e. a sound field with added spatial information is created. Without these reflections, the sound would be perceived as emanating from inside of the listener's head.

Stereophonic Reproduction and its Limitations

We are quite used to stereophonic reproduction and we are very familiar with its limitations, to the point where we don't think much about them anymore. This doesn't mean that we don't hear the difference between stereophonic reproduction and live sound, most would agree that it's easy to distinguish between live and stereo reproduced sound, it's just that we don't expect stereo to sound like live sound and automatically without thinking about it filters the process out and changes our expectations. At best, using ordinary properly setup loudspeakers, stereo reproduction can project a sound stage with depth, width and height. The sound sources within that soundstage unfortunately sound like they were paper cutouts of performers without any individual extension in depth. Furthermore, the paper cutouts perform in solitude without being in an acoustic space, almost like flashlights suspended in a black room projecting their sound only straight forward towards the listener. There is some ambience information present in stereo reproduction that allows us to hear the acoustic surroundings in which the recording was made but it is not anything remotely resembling the acoustics of a real space.

Picture 1, shows two cross sections of two rooms. The larger room is a typical concert hall with a stage section to the left and the audience space to the right. There's a single performer on stage and a single listener in the audience. The sound emanates from the performer on stage travelling along a number of imaginable paths illustrated in the picture. The direct sound travels directly from the performer to the listener without reflecting on any surfaces within the hall. As can be seen, the path of the direct sound is much shorter than the path of the first reflection reaching the listener which creates an appreciable arrival time difference.

The smaller room at the bottom in Picture 1 is a typical listening room with a loudspeaker to the left and a listener to the right. Again soundwave paths are illustrated in the picture with a direct path and reflected paths. In the smaller room the path length difference between the direct sound and the first reflection is smaller than in the larger hall which translates into a smaller arrival time difference.

One of the fundamental differences between the hall and the room is the reverberation time. The larger hall has a much longer reverberation time than the small room. In a larger space, over the same time, there are fewer sound wave reflections. In the large space, sound has to travel a longer distance before reaching the next reflecting surface that absorbs energy from the sound field and thus the sound lingers for a longer period of time in the larger space.

Picture 2 illustrates the arrival of sound at the listener's ears in five different diagrams. Along the X-axis is time and on the Y-axis is level. The five diagrams show reverberant decay spectra from an impulse sound. Diagram 1 is from the concert hall in Picture 1, diagram 2 is from the listening room in Picture 1, diagram 3 is a stereo recording made in the concert hall shown in diagram 1, diagram 4 is the stereo recoding played back in the listening room and finally diagram 5 shows the stereo recoding played back in the listening room after it has been Stereo Unfold processed.

In the first diagram in Picture 2 from the concert hall in Picture 1 the first peak to the left is the direct sound arriving from the performer to the listener. The next peak is the first reflection arriving after a certain time delay. Following the first are the later reflections, first those that have bounced on only one surface sparsely spaced followed by an increasingly dense array of reflections from multiple bounces. This is typical impulse response decay observable in many halls.

The second diagram in Picture 2 shows the same kind of sound arrival as the first diagram but now it is shown from the typical listening room in Picture 1. Again we have the direct sound, the first peak, followed by the early somewhat sparsely spaced reflections and the denser multiple reflection paths that follows. The sound in the small room is absorbed quicker than in the hall which is clearly illustrated by comparing the sound decay in diagram one and two in Picture 2.

The most critical difference between the hall and the room is the timing of the first reflection in relation to the direct sound. It's well known from concert hall acoustics that there should be about 25 ms to 35 ms between the direct sound arrival and the first reflection to maintain clarity and intelligibility of the sound in the hall. If this time is reduced the sound becomes less clear, unprecise even to a point where it becomes fatiguing. The small room isn't physically large enough to provide us with this amount of delay and therefore added ambient energy in the room invariably makes the sound less clear.

There is one fundamental limitation inherent in current stereo reproduction that it's necessary to understand in order to address the performance shortcomings that come as a consequence of it.

Our stereo recordings are missing all spatial information apart from some left to right localization clues [5]. This is easy enough to test by listening to a stereo recording using headphones, the sound is invariably located inside the listener's head between the ears. With this example some will claim that it is because the reproduction hasn't got an individualized head related transfer function (HTRF) correction. So, let's redo the test with a pair of highly directional speakers, parabolic speakers or speakers in an anechoic chamber. The sound stage is still located within the listener's head. How can it be, we have just added a perfect individualized HRTF to the reproduction?

The problem isn't in the reproduction but rather the recording. If we had recordings made with individualized HTRFs, i.e. one custom dummy head for every person that is going to listen to the recording, we could all listen to headphones and decode the spatial information properly. Unfortunately, this can't be done for obvious reasons so we are left with recordings that lack any meaningful spatial information.

How can we then perceive a sound stage in front of us with depth, width and height when we listen in the sweet spot of a properly setup stereo system? The stereo speakers and the listening room work together to create the sensation of a three-dimensional sound stage in front of us but this is just an illusion created by the speakers and the listening room together, it is not something that is encoded in the stereo recording. The speakers are together with the listening room creating a spatial sound field within the listening room that the human brain can decode. This spatial sound field has however no resemblance to the sound field present at the recoding venue.

There are speakers with different radiation patterns that bring about the three-dimensional space illusions in slightly different ways but all exhibits various problems related to their particular approach. The most common speaker type is more or less replicating a point source in its forward radiating direction with mid to high frequencies predominantly spreading the sound towards the listening position, i.e. a speaker with cones and domes facing forward. This type of speaker is usually not very successful in creating a three-dimensional sound stage and the degree of success relies on several variables that are difficult to control. The loudspeaker's of axis radiation pattern need to be controlled in the sense that it need to have good frequency and time domain behavior for the three-dimensional illusion to work, something that is difficult to obtain with traditional designs. The sound stage will be more three dimensional and spacious the more energy that is radiated in directions other than directly towards the listener. Unfortunately, the sound stage will, at the same time, become fuzzier, the outlines of individual performers and their location within the three-dimensional space become less clear and it loses over all clarity. The reason for this is that the added ambient spatial sound field reaches the listener almost at the same time as the direct sound from the loudspeakers and the listener's brain therefore fails to decode the spatial information and consequently the sound becomes unclear. The sound also becomes increasingly dependent on the acoustics of the listening room. Both the acoustics and the room, the size of the room and the location of the speakers within the room, influence the perception of clarity, localization and the accuracy of the tonal balance. The forward focused radiation pattern also creates somewhat of a sound flash light effect, blinding the listener with a high amount of direct radiated sound which is very unnatural.

When a point source radiates equal amounts of energy in all directions at all frequencies it is usually called and omnidirectional speaker. This type of speaker exhibits a more natural sounding three-dimensional illusion but the sound is lacking clarity and the localization of individual performers is not good. The frequency response accuracy is also highly influenced by the surroundings. Disregarding its obvious drawbacks, lack of clarity, resolution and dependence on the room, it creates the best illusion of a three-dimensional event occurring in front of the listener using traditional technology. This occurs because an omnidirectional speaker radiates more energy into the ambient space of the listening room in relation to the direct sound towards the listener and replicates the direct sound to ambient sound ratio in a concert hall better than an ordinary forward radiating speaker.

There are numerous variations and crossovers between speaker types but in summary the more sound energy a speaker radiate in other directions than towards the listener the more convincing the three-dimensional illusion becomes. At the same time the sound loses clarity, localization because of the short difference in arrival time between direct and ambient sound and becomes more dependent on placement and the acoustics of the listening room.

Furthermore, traditional loudspeakers scale the size of the sound stage and the instruments therein to their own size. A small speaker invariably sounds smaller than a large speaker [4]. It is easy to distinguish the size of a small speaker compared to a large speaker in blind listening tests and in all but perhaps a very few extraordinarily unusual cases the reproduced sound stage from stereo is smaller than the original recorded sound stage.

Humans can immediately and intuitively without thinking about it judge the physical size of any sound source. This is a vital survival skill, we need to know if the sound emanates from something big and potentially life threatening or if it is just a small harmless thing. We judge the size of the object by listening for the spatial properties of the generated sound field. A small object spatially radiate sound at particular frequencies differently from a larger object, when the surfaces radiating the sound become larger compared to the wavelength of the sound the radiation becomes increasingly directional.

A loudspeaker creates an illusion of a three-dimensional sound stage using its own size combined with the reflections it generates within the listening room, the created spatial sound field. Since the stereo recording doesn't contain any viable spatial information the illusion is purely built on the spatial properties of the sound generated by the speaker and the room together. If one considers this, it becomes quite obvious that a small speaker will sound smaller than a large since it spatially radiates sound in the same way as a small object. Our ability to detect the size of an object has been developed over many thousands of years and an ordinary small speaker doesn't manage to fool our hearing into believing it is a large object.

The reflections generated within the listening room create the illusion of a three-dimensional sound stage that seems to exist outside of our head in front of us. A lager room gives us a larger sound stage and in a small room we only get a much smaller stage. Without the spatial sound field generated by the speaker and room together we have no illusion of a three-dimensional soundstage since the stereo recoding lacks this information. The sound stage generated by the speaker and the room has nothing to do with what's recorded, it is just an illusion generated in a particular room by a particular speaker and it will change completely if the speaker is moved to another room.

The second problem with stereo has its roots in the same lack of spatial information within the recoding and reproduction chain. A recording engineer would not place a recoding microphone at a typical listening position in a concert hall. He would invariably move the microphone much closer to the performers. If the microphone was located out in the hall where the audience usually sits the recording would sound excessively reverberant an unnatural. This happens because the stereo recording fails to capture the spatial information properties from the sound field in the hall. It only captures the sound pressure level. A human listener in the hall would capture all of the information, both sound pressure and spatial, and would automatically use the spatial information to focus his/her attention to the performers on stage. The ambient sound field is reaching the listener from other directions and is both perceptibly attenuated and observed differently by the brain compared to the sound from the stage. Since spatial information is missing from stereo recordings the listener can't use any spatial information to decode it and therefore if the recording was made at the listening position in the hall it would be perceived as having copious amounts of reverberant energy. The human brain uses both the spatial domain as well as the sound pressure domain to understand and process the sound environment.

Barron investigated the ratio between reflected energy and direct energy and created a diagram that ranges from −25 dB to +5 dB (D/R) to cover any normal circumstances [1]. In a typical shoebox concert hall at least half the seats have a D/R of −8 dB or less [4]. In nearly all stereophonic recordings the D/R ratio is never less than +4 dB, i.e. there is at least a 12 dB difference between the recoding and the sound in the concert hall. This is necessary since the recoding lacks spatial information and listeners can't distinguish the reverberant field in the recording from the direct sound. If the recoding contained as much reverberant energy as present in the hall it would sound disproportionately reverberant.

In summary, a stereophonic recording has at least 12 dB less reverberant energy contained within it than the original and it lacks any spatial information of the sound field.

To make things worse the most common forward radiating loudspeaker beams most of the sound energy directly towards the listener and doesn't improve much on the lack of reverberant field energy in the recoding. An omnidirectional speaker works much better in this regard and as a result the three-dimensional sound stage becomes more convincing. Unfortunately, the larger amount of reverberant field energy in the listening room negatively influences the perception of clarity, localization and the accuracy of the tonal balance.

The reason is that there is only a small amount of time delay between the direct sound and the reverberant three-dimensional sound generated by the speaker and the room together. In a typical listening room, the time difference between the direct sound and the first reflected sound reaching the listener is around 5 ms. This is the root of the problem, there simply is not enough time for the listener to separate direct and reverberant sound and hence the whole sound becomes clouded congested, and imprecise [3].

Picture 2 diagram 3 illustrates the reverberant decay in a stereo recording captured in the hall illustrated in Picture 1. A difference between the recording and the hall shown in Picture 2 diagram 1 exist because as discussed above the recording engineer had to move the microphone closer to the performer to balance the stereo recording. Since the microphone now is much closer to the performer the hall reflections are attenuated in relation to the direct sound. Additionally, the recorded reflections are not predominantly those of the main hall anymore but due to the physically closer proximity of the adjacent surfaces in the stage section those become dominant rather than the sparsely spaced reflections in the main audience section of the hall. On the whole it is rather obvious looking at the diagrams that the entire captured reverberant field in the stereo recording is not very similar to the naturally occurring field at the listening position in the hall.

Picture 2 diagram 4 shows what happens when the recording shown in Picture 2 diagram 3 is played back by the speakers and room with a reverberant decay illustrated in Picture 2 diagram 2. Here the recorded reverberant decay becomes superimposed on the room reverberant decay resulting in the composite reverberant decay in Picture 2 diagram 4. This still doesn't at all look like the reverberant decay of the hall in Picture 2 diagram 1 but it's the decay typically found in a listening room upon playback of a stereo recording.

As mentioned before the lack of time spacing between direct sound and first reflection makes the sound less clear and precise to the point of becoming fatiguing. The small room sound clearly causes trouble for the human brain and it also lacks enough reverberant decay energy to emulate a concert hall.

Considering that stereo sound lacks all spatial information, the spatial sound field is only created within the listening room by the speakers and the room together, and that the decay pattern looks very dissimilar to what naturally occurs in a music hall it's not very surprising that stereo sounds artificial.

Stereo Unfold Technology

The Stereo Unfold Technology solves the inherent problems in the stereo reproduction by utilizing modern DSP technology. With a DSP it is possible to easily extract information from the Left (L) and Right (R) stereo channels to create a number of new channels that feeds into other processing algorithms. A DSP can also delay, frequency shape and blend these different feeds together.

Stereo Unfold addresses the two fundamental limitations in stereo by regenerating a psychoacoustically based spatial 3D sound field that the human brain can easily interpret and by utilizing the psychoacoustic effect called psychoacoustic grouping.

In the first implementation Stereo Unfold creates a spatial 3D sound field in the listening room through the use of additional drivers in other directions than forward together with basic grouping of the spatial field and the direct sound.

In a second implementation Stereo Unfold uses the disclosed enhanced grouping method together with ordinary loudspeakers. The forward radiating loudspeaker essentially first plays back the stereo information and then later the grouped spatial information to recreate the spatial field without the use of additional drivers aimed in other directions than forward. This is possible through the use of the enhanced grouping process that uses the later described sympathetic grouping method.

In a third implementation Stereo Unfold creates a spatial 3D sound field in the listening room through the use of additional drivers in other directions than forward together with enhanced grouping of the spatial field and the direct sound. This implementation recreates the best illusion but needs additional drivers and is thus somewhat limited in its applicability compared to the second implementation.

In a fourth implementation Stereo Unfold processing creates a spatial 3D sound field with headphones using the enhanced grouping process. The direct and ambient sound fields are connected through enhanced grouping which moves the sound experience from the common within the listener's head to outside of the listener's head. It does so without any prior information about the listener's physical properties, i.e. shape and size of ears, head and shoulders.

Picture 2, diagram 5 illustrates the sound field generated by Stereo Unfold reproduction of the stereo recording from Picture 2 diagram 3 in the room in Picture 2 diagram 2. Stereo Unfold extracts the reverberant decay of the hall shown in Picture 2 diagram 1 from the stereo recording in Picture 2 diagram 3, amplifies it and locates it in time where it makes psychoacoustic sense to the human brain. The room response from Picture 2 diagram 3 is of course still superimposed on the playback but the Stereo Unfold version of playback looks much more similar to the acoustic decay pattern from the hall in Picture 2 diagram 1 than stereo and also provides plenty of easily understandable acoustic information to the listener's brain. The new decay field is possible though psychoacoustically consonant spatial field generation and psychoacoustic grouping.

Picture 3 below of a symphony orchestra and two speakers is an attempt to visually illustrate the sound from stereo. Most of the soundstage is perceived as being in between the two speakers with a little bit of height and depth and virtually no acoustic surrounding.

Picture 4 visually illustrates the perceived soundstage from Stereo Unfold and it should be compared to Picture 3 that is illustrating ordinary stereo. The performers are located approximately at the same locations somewhat enlarged in size, the hall and ambiance is added as well as a 3D quality to the sound.

Unfolding Stereo

As implied by the name, Stereo Unfold is unfolding the ordinary stereo recording much like mono once was unfolded physically into left/right stereo but this time stereo is unfolded in the dimension of time. The jump from stereo to Stereo Unfold is psychoacoustically actually not much different from physically unfolding mono into stereo. This might sound inexplicable but let's take a closer look at stereo and how it works psychoacoustically and it will become apparent that it's not.

The localization of sound sources from left to right in stereo playback works through two main psychoacoustic phenomena. Our ear brain judges horizontal localization of a sound source based on inter aural time differences and perceived level differences between left and right ear. It is possible to pan a sound source from left to right by adjusting the level from the source in the right and left ear respectively. This is usually referred to as level panning. It is also possible to adjust the localization by changing the arrival time to the left and right ear and this panning method is the more effective of the two. It is easy to test the effectiveness of panning through inter aural time difference. Set up a stereo speaker pair in front of a listener and allow the listener to move away to the left or right from the centrally located position between the speakers. The perceived soundstage rather quickly collapses towards one of the stereo speakers because the interaural time difference psychoacoustically tells us that the closer speaker is the source. The same can be illustrated using headphones, by delaying the stereo signal to one of the ears the whole soundstage collapses towards the non-delayed ear without any change in level. Localization in the horizontal plane in stereo is actually predominantly caused by the inter aural time difference between the left and right signals, i.e. stereo is a mono signal unfolded in time to generate psychoacoustic horizontal localization clues based on time differences between the ears. Blumlein used the physical separation of two speakers to be able to create the necessary inter aural time difference for the creation of left to right localization.

Now, if we, similarly as mono was unfolded into stereo, unfold the stereo signals in time we will psychoacoustically be able to unfold stereo into a true tree dimensional sound. This is what Stereo Unfold does.

Picture 5 shows one channel of an ordinary digital stereo sound recording. Along the axis starting to the left and ending in the middle of the picture we have sound samples on the real time domain axis. The graph displays the absolute value of the sound signal at each instance in time, height corresponding to level. Along the axis from the right to the middle of the picture we have the second dimension of time. In the original stereo recording there is no additional information in this dimension since stereo is just a two-dimensional process only containing left and right signals.

Picture 6 shows the same digital stereo sound recording as Picture 5. The difference is that it has now been Stereo Unfold processed. It has been unfolded in time and along the axis from right to center we can now see how the signal at each instance in time is unfolded into the secondary time dimension. In the diagram it can be observed that the signal is unfolded by an unfold process using 20 discrete unfold signal feeds along the secondary time axis. The concept of the 3D-graph in Picture 6 is perhaps somewhat strange on first look but it very much resembles how the human brain interprets sound. A sound heard at a certain point in time is tracked by the brain along the secondary time axis and all information from the onset of the original signal up to the end in the diagram is used by the brain to obtain information about the sound.

The brain tries to make sense of our sound environment in much the same way as our vision. It simplifies the sound environment by creating objects and assigning particular sounds to each object [2]. We hear the doorbell as an object together with the attendant reverberation, when a person walks across the room we assign all the sounds from the movement to the person etc. An example from our visual perception and grouping perhaps makes the details easier to understand. Think about a small tree with green leaves and a man standing behind the tree. Looking at the tree and man we immediately group the branches and leaves of the tree together into a tree object and we deduct from the portions that are visible of the man behind the tree that there is another object, although only partially visible at this point, and groups it into the man group. Our perception of the man group is limited since the leaves obscures most of the man but still we manage to tell with reasonable certainty that it is a separate group and most likely it's a man. The visual example is similar to how our hearing works and how the brain decodes and groups sound. Even if the brain only has partial limited information it is still possible to perceive and group sound objects, much like the man behind the tree. The less information we hear the harder it is with certainty to sort out details and group but it's still possible, the brain only has to work harder. If the tree didn't have any leaves, we would be able to see more details and perceive the man group behind the tree much easier and with greater certainty.

With this in mind, take another look at the differences between Picture 5 and 6. In the unfolded version of the signal in Picture 6 there is a lot more information about the sound and consequently makes it easier for the brain to sort out, perceive details and group the sound. This is exactly what's heard with Stereo Unfold compared to ordinary stereo, increased ease and an increased perception of details. The acoustic environment and decay associated with each sound becomes much clearer and the soundstage takes on a 3D quality that isn't present with ordinary stereo. The overall size of the soundstage is also significantly increased.

The graph in Picture 6 has two time dimensions and the additional second time dimension in the matrix is during the processing dimension folded into the real time dimension.

Stereo Unfold Spatial Sound Field Creation

The Stereo Unfold Technology creates a real believable three-dimensional soundstage populated with three-dimensional sound sources generating sound in a continuous real sounding acoustic environment. This is accomplished by extracting information from the stereo source material to restore the, in live sound, naturally occurring ambient to direct sound ratio and by spatially spreading the sound in a controller manner into the listening room. It operates by sending the ordinary stereo information in the customary way towards the listener to establish the perceived location of performers in the sound field with great accuracy and then projects delayed and frequency shaped extracted signals forward as well as in other directions to provide additional psychoacoustically based clues to the ear and brain. The additional clues generate the sensation of increased detail and transparency as well as establishing the three dimensional properties of the sound sources and the acoustic environment in which they are performing. The inserted clues provide the human brain with more information to work with and make the decoding of the sound much easier requiring less effort compared to ordinary stereo reproduction.

The ideal Stereo Unfold speaker has speaker drivers located not just facing forward towards the listener but also facing left, right, up and to the back. A down firing driver can also be used albeit with somewhat limited benefits. A driver in this context is one or many sound generating devices which could be as an example one full-range driver, several drivers using crossovers to divide the frequencies appropriately between them or several drivers all reproducing the same sound possibly also combined together with some other drivers using a crossover. Any driver technology could be used from traditional cone drivers to electrostatic drivers and magnetostatic drivers etc. The driver technology is not of any particular importance and any sound generating technology would work well. The radiation pattern of each of the individual drivers can be regular forward firing, similar to an ordinary cone, dome or horn, but also line source, omnidirectional or dipole or variations and combinations thereof.

The processed feeds from the algorithms are typically played back through speaker drivers located on the front, sides, top and rear of an otherwise ordinary looking loudspeaker in order to spread sound in the listening room, i.e. generation of a spatial 3D sound field, in a controlled manner generating a believable soundstage resembling live sound. The Stereo Unfold technology will work with less than all the additional drivers, even as little as one additional driver that aren't facing directly forward will be able to enhance the traditional stereo reproduction albeit not to the same extent as when implemented with all drivers in place. Also, the drivers don't necessarily need to be oriented straight back, up, sideways or forward. The technology will work well with drivers angled differently not purely in one of the given directions.

The Stereo Unfold technology is preferably implemented within two ordinary looking speakers, one speaker per stereo channel, with drivers in the aforementioned directions. It can also be realized using additional enclosures which are added as supporting speaker units to any type of conventional stereo speaker, at least one for each stereo speaker but could be any number. They can either be placed on top of or attached in some way to an ordinary speaker enclosure or placed separately as a standalone speaker. The additional Stereo Unfold speakers can also be hanged on walls or mounted inside walls.

The DSP extraction process creates the additional L+R, L-R and R-L feeds that are used together with the original L and R channels in the processing. The equations for the most basic feeds (Fx) are show below; Gx, Dx, and Frx denotes gain, delay and frequency shaping respectively.

F1=L

F2=R

F3=L*G1*Fr1*D1

F4=R*G2*Fr2*D2

F5=(L*G3*Fr3*D3)+(R*G4*Fr4*D4)

F6=(L*G5*Fr5*D5)−(R*G6*Fr6*D6)

F7=(R*G7*Fr7*D7)−(L*G8*Fr8*D8)

The Gx gain multipliers can be any number between 0 and infinity. The frequency shaping, Frx, predominantly limits the frequency range to above 50 Hz to be able to among other benefits use smaller drivers with limited output capability and the higher frequency contents is rolled of above 7 kHz to emulate typical reverberant field energy in a concert hall and naturally occurring absorption of higher frequencies in air. The preferred frequency range being 100 Hz to 4 kHz. It also contours the response to follow the roll of in an ambient sound field similar to what's naturally occurring in concert halls. The delays Dx are at least 5 ms up to 50 ms, preferred range 10 ms-40 ms, further preferred range 15 ms-35 ms. The shown basic feeds F3-F7 can each become several input feeds to the processing with different Gx, Frx and Dx settings. In the below following text and equations a reference to any of the feeds F3 to F7 denotes at least one but can also be two, three, four, five or several more of the same basic feed with different Gx, Frx, and Dx in each instance. In the example implementations below there is another delay element Dfx which is used to decorrelate one feed to any particular driver with a similar feed to another driver. The delay can be anything between 0-30 ms depending on loudspeaker enclosure design and driver location.

In one example implementation of the Stereo Unfold technology using drivers in all five basic directions, forward, sideways, back and up the following feeds are used for the different drivers.

Left Speaker

Forward=(L*G9)+(F6*G10*Fr10*Df1)

Inward=(F3*G11*Fr11*Df2)+(F5*G12*Df3)

Outward=F6*G13*Df4

Upward=F6*G13*Df4

Backward=(F6*G13*Df4)+(F3*G14*Fr14*Df5)

Right Speaker

Forward=(R*G9)+(F7*G10*Fr10*Df1)

Inward=(F4*G11*Fr11*Df2)+(F5*G12*Df3)

Outward=F7*G13*Df4

Upward=F7*G13*Df4

Backward=(F7*G13*Df4)+(F4*G14*Fr14*Df5)

In another example in a somewhat simpler implementation still using drivers in all five basic directions, forward, sideways, back and up the feeds are configured in this way.

Left Speaker

Forward=(L*G9)+(F6*G10*Fr10*Df1)

Inward=F3*G11*Fr11*Df2

Outward=F6*G13*Df4

Upward=F6*G13*Df4

Backward=(F6*G13*Df4)+(F3*G14*Fr14*Df5)

Right Speaker

Forward=(R*G9)+(F7*G10*Fr10*Df1)

Inward=F4*G11*Fr11*Df2

Outward=F7*G13*Df4

Upward=F7*G13*Df4

Backward=(F7*G13*Df4)+(F4*G14*Fr14*Df5)

In still another example using drivers in all five basic directions, forward, sideways, back and up the feeds are configured in this way.

Left Speaker

Forward=(L*G9)+(F6*G10*Fr10*Df1)

Inward=F3

Outward=F6*G13*Df4

Upward=F6*G13*Df4

Backward=F6*G13*Df4

Right Speaker

Forward=(R*G9)+(F7*G10*Fr10*Df1)

Inward=F4

Outward=F7*G13*Df4

Upward=F7*G13*Df4

Backward=F7*G13*Df4

Another example using drivers in all five basic directions, forward, sideways, back and up the feeds are configured in this way.

Left Speaker

Forward=L

Inward=F3

Outward=F6

Upward=F6

Backward=F6

Right Speaker

Forward=R

Inward=F4

Outward=F7

Upward=F7

Backward=F7

In another example using drivers in four basic directions, forward, sideways and up the feeds are configured in this way.

Left Speaker

Forward=(L*G9)+(F6*G10*Fr10*Df1)

Inward=F3+(F6*G15*Fr15*Df5)

Outward=F6*G13*Df4

Upward=F6*G13*Df4

Right Speaker

Forward=(R*G9)+(F7*G10*Fr10*Df1)

Inward=F4+(F7*G15*Fr15*Df5)

Outward=F7*G13*Df4

Upward=F7*G13*Df4

In another example using drivers in three basic directions, forward, inward and up the feeds are configured in this way.

Left Speaker

Forward=(L*G9)+(F6*G10*Fr10*Df1)

Inward=F3+(F6*G15*Fr15*Df5)

Upward=F6*G13*Df4

Right Speaker

Forward=(G*G9)+(F7*G10*Fr10*Df1)

Inward=F4+(F7*G15*Fr15*Df5)

Upward=F7*G13*Df4

In another example using drivers in two basic directions, forward and inward the feeds are configured in this way.

Left Speaker

Forward=(L*G9)+(F6*G10*Fr10*Df1)

Inward=F3+(F6*G15*Df5)

Right Speaker

Forward=(G*G9)+(F7*G10*Fr10*Df1)

Inward=F4+(F7*G15*Df5)

There are an infinite number of possible combinations and all can't be exemplified but the general approach should now be apparent. The ordinary L and R signal are sent to the forward facing drivers and the extracted and processed signals of various origins are sent in appropriate directions both to other drivers and possibly also through the forward facing drivers. The exact choice of algorithms depends on the particular properties of the implementation. Things like driver dispersion pattern, location on the speaker enclosure, aiming direction and angle and number of drivers employed all influences the optimal choice of algorithms.

It would be easy to think the Stereo Unfold technology is just about adding echoes to the stereo signals but what it does is very far removed from the common DSP echo effects ubiquitously present in all types of DSP equipped audio devices and software plugins etc. The Stereo Unfold technology exploits a psychoacoustic phenomenon to figuratively speaking paint the spatial 3D sound space. The 3D sound field is created within the listening room. The human ear and brain sort out the location and size of a sound source as well as the initial properties of the ambient acoustics within a certain time frame after the sound was first heard. This time frame is about 5 ms to 50 ms after the onset of the sound. Sound arriving before 5 ms is interpreted as a part of the so called direct sound from the source and is not useful for the spatial 3D recreation. Sounds that arrive after 50 ms are perceived as echoes and cannot be used in the spatial 3D process either. Sounds arriving in between 5 ms and 50 ms, again figuratively, paint the spatial 3D sound picture we perceive when listening and provide our ear brain with all sorts of clues about the properties of the sound.

With the Stereo Unfold technology the initial sound arriving at the listener's ear is the L and R signals that are launched before any of the extracted feeds. With the proper time delay, clarity, detail, image specificity and timbre is actually greatly enhanced by the added feeds. This happens because the added feeds make the process of decoding the sound much easier for the ear brain since there are so many more clues to work with. The Stereo Unfold decoding is much easier for the ear brain than stereo decoding, actually approaching a situation akin to sound from a live performance.

Also, the Stereo Unfold technology doesn't add any kind of perceptible echo to the sound, if the acoustic of a recoding is dry the Unfold version sounds dry and if it is wet it sounds wet. The recoded acoustic environment comes through truthfully and changes completely between recordings with different acoustic ambiance.

The size of the loudspeaker becomes more or less unimportant because the Stereo Unfold technology's 3D painting of the sound fools the ear brain. The ear brain can no longer detect the size of the loudspeaker because there are so many other clues to the size of the sound sources and soundscape that the loudspeaker's size is not dominant anymore.

Finally, the acoustic properties of the listening room become less important than with any ordinary stereo reproduction since the sound field projected into the room by the Stereo Unfold technology already has very good acoustic ambiance properties added to it and it's already delayed enough to be perceived as ambient sound by a listener. The listening room doesn't have a chance to influence the sound in the same way that it does with stereo reproduction anymore.

Stereo Unfold with Enhanced Grouping

The enhanced grouping process is essential for Stereo Unfold to work on headphones and ordinary speakers lacking the additional drivers aimed in other directions than forward towards the listener. In a live situation the human brain uses both the spatial sound field information and the sound pressure level to interpret the acoustic environment, i.e. to group the sound objects together. Since stereo recordings miss all spatial information the grouping process is considerably harder for the brain when solely relying on sound pressure information and as a consequence the reverberant level needs to be reduced as discussed earlier. When the Stereo Unfold Technology restores the ambient information, without the enhanced spatial control of the created sound field in the listening room offered by the additional drivers aimed in different directions, it has to provide the brain with sound organized to assist the grouping process. This is the purpose of the enhanced grouping method described below.

The Stereo Unfold DSP extraction process creates additional basic L+R, L-R and R-L feeds that are used as building blocks together with the original L and R channels in the unfold processing. The equations for the basic feeds (Fx) are show below; Gx, Dx, and Frx denotes gain, delay and frequency shaping respectively, Gfx are gain multiplies to adjust forward main output in level to maintain same perceived output level after the Stereo Unfold processing and Frfx are frequency shaping filters that can be modified to maintain the overall tonal balance of the forward direct sound.

F1=L*Gf1*Frf1

F2=R*Gf2*Frf2

F3=L*G1*Fr1*D1

F4=R*G2*Fr2*D2

F5=(L*G3*Fr3*D3)+(R*G4*Fr4*D4)

F6=(L*G5*Fr5*D5)−(R*G6*Fr6*D6)

F7=(R*G7*Fr7*D7)−(L*G8*Fr8*D8)

F8=L*G9*Fr9*D9

F9=R*G10*Fr10*D10

The Gx gain multipliers can be any number between 0 and infinity. The frequency shaping, Frx, predominantly limits the frequency range to above 50 Hz and rolls of frequencies above 7 kHz to emulate typical reverberant field energy in a concert hall and naturally occurring absorption of higher frequencies in air. The preferred frequency range being 100 Hz to 4 kHz. It also contours the response to follow the roll of in an ambient sound field similar to what's naturally occurring in concert halls. The delays D1 and D2 are between 0 ms-3 ms, the rest of Dx are at least 5 ms up to 50 ms, preferred range 10 ms-40 ms, further preferred range 15 ms-35 ms. The shown basic feeds F3-F9 can each become several input feeds to the processing with different Gx, Frx and Dx settings. In the below following text and equations a reference to any of the feeds F3 to F9 denotes at least one but can also be two, three, four, five or several more of the same basic feed with different Gx, Frx, and Dx in each instance.

In a basic implementation of Stereo Unfold using 5 unfold feeds the following signals are played back according to the equations.

Left Channel=F1+F3+F6+F8+F5

Right Channel=F2+F4+F7+F8+F5

In a very simple implementation down to minimum 3 unfold feeds can be used. An enhanced version can utilize 20 feeds as illustrated in Picture 6 and there is no upper limit of number of feeds, it's only limited by available DSP processing resources. Going above 30 feeds with perceptibly significant contents only brings limited advantages to the audible experience and could become detrimental so a preferred range is between 3 to 30 feeds. Below 3 feeds doesn't work since there is no psychoacoustically valid grouping information and the result is compromised.

Another basic implementation of Stereo Unfold using 3 Unfold feeds, the signals are played back according to the following equations.

Left Channel=F1+F3+F6

Right Channel=F2+F4+F7

In a more advanced implementation of Stereo Unfold using 12 Unfold feeds, the signals are played back according to the following equations. The “2*” denotes the number of times each feed is used with different parameters for Gx, Frx, and Dx in each instance.

Left Channel=F1+2*F3+4*F6+2*F8+F5

Right Channel=F2+2*F4+4*F7+2*F8+F5

There are of course an infinite number of possible combinations and all can't be exemplified but the general approach should now be apparent. The Left and Right Channel signals in the examples can be played back both through headphones and/or ordinary loudspeakers.

When played back through loudspeakers, in addition to the Left Channel and Right Channel signals, the Stereo Unfold feeds without the F1 and F2 components can also be sent to drivers aimed in other directions than directly towards the listener. Additional feeds can be sent in one or all possible extra directions, in, out, up, back and down, using any type of loudspeaker drivers or arrays thereof. Basically any type of constellation that generates a diffuse widespread sound field will work. Also additional separate loudspeakers can be used for the additional feeds located close to or even possibly attached to the main speakers. Separate loudspeakers can also be located around the room similar to a surround setup or integrated into the walls and ceiling. Also any type combination of the above is possible and will work.

The psychoacoustic grouping phenomenon is core to the Stereo Unfold process. Without grouping the brain would not connect the time layered feeds together and they would not provide additional information to the brain, rather the opposite, they would provide confusion and would make the sound less clear and less intelligible. Grouping is easier to describe in an uncomplicated example so let's take a closer look at the Left channel signals in the 3 Unfold feed example above with the output equation;

Left Channel=F1+F3+F6.

In this case we have a sound in the F1 direct feed that also appears in the F3 and F6 feeds and we need to group them. The better and more stable the psychoacoustic grouping is the better the audible result become and intelligibility improves.

It is understood from psychoacoustic research that grouping occurs based on phase relationship and frequency relationship of the original direct sound signal and the added information. If the frequency shape differs between direct sound and added feed the added feed need to retain a phase and frequency contents that is in line with what the human brain expects from a signal present in a real acoustic environment. What this means is that if we have a direct sound and a second feed that arrives a certain time later the brain would expect the second signal to have less high frequency contents than the direct sound dependent on the distance and time it traveled to reach the listener. A signal that has traveled for 25 ms, equating approximately 8.5 meters, have to exhibit high frequency roll off at least equal to the amount present in air at that distance. If it has the same frequency contents as the direct signal it will be confusing for the brain and the brain won't group it with the direct sound as intended. If it has less high frequency contents it becomes more believable since the sound apart from just travelling in air most likely also bounced on at least one object and that the reflection in itself also removed high frequency contents. Similarly, a reflection of a smaller object won't bounce much of the low frequency energy back and the reflected sound will be rolled of below a certain frequency depending on the physical size of the object in relation to the wave length. In essence, to achieve good grouping the signals in F1, F3 and F6 need to adhere to the laws of physics and they need to have similar frequency contents modified according to travel distance etc. as described.

Another important propriety for the enhanced grouping to occur is phase relationship. If the signals in feed F1 and F6 are random in their phase relationships, they won't be grouped without the spatial information from the recording venue which the stereo recoding is missing.

The low frequency roll off in combination with the delay work together to establish grouping and enhanced sympathetic grouping occurs at different combinations of delays and frequency roll off. If we roll off at say 250 Hz a delay causing sympathetic grouping would be a multiple of the fundamental, i.e. 4 ms*6=24 ms. It has been found that although the delay is long compared to the fundamental frequency it is important that the lowest frequency still is in phase with the direct feed for a good grouping to occur. The example above gives us a delay of 24 ms. This is not an exact value in the sense that it needs to be exactly 24 ms or grouping won't occur. It's rather a middle point within a range where grouping occurs and should be viewed as a guiding point towards a delay where grouping will occur.

The F3 feed is needed to group together with F1 and F6 in order to provide phase stabilization to the sound. The F6 feed is essentially an L-R feed and as such if added in significant amounts will cause a somewhat unpleasant phasiness to the sound to a certain degree similar to what happens when playing back stereo contents with one of the speakers out of phase. To counteract this phenomenon, the F3 feed is provided as a stabilizing element that removes the phasiness and when grouped with the F1 and F6 feeds there is no phasiness present anymore.

Applications & Technical Solution

Stereo Unfold can be applied to a sound recording at any stage. It can be applied on old recordings or it can be applied in the process of making new ones. It can be applied off line as a preprocess that adds the Stereo Unfold information to recordings or it can be applied whilst the sound recording is played back.

There are multiple ways of implementing it into products, it could be either in hardware form in an integrated circuit on a chip, FPGA, DSP, processor or similar. Any type of hardware solution that allows the described processing can be used. It can also be implemented into a hardware platform as firmware or software that runs on an already present processing device such as a DSP, processor, FPGA or similar. Such a platform could be a personal computer, phone, pad, dedicated sound processing device, TV set etc.

The Stereo Unfold can then be implemented in any type of preprocessing or playback device imaginable either as hardware, software or firmware as described above. Some examples of such devices are active speakers, amplifiers, DA converters, PC music systems, TV sets, headphone amplifiers, smartphones, phones, pads, sound processing units for mastering and recording industry, software plugins in professional mastering and mixing software, software plugins for media players, processing of streaming media in software players, preprocessing software modules or hardware units for preprocessing of streaming contents or preprocessing software modules or hardware units for preprocessing of any type of recording.

Other Application Areas

During the work with Stereo Unfold we have also discovered that the improvement in clarity of the sound perceived by a normal listener is of even greater importance to a listener with hearing impairment. Listeners with hearing impairment are regularly struggling with intelligibility of sound and any relief brought is of great help.

The added clues provided by Stereo Unfold reduce the difficulties by offering more information for the brain to decode and more clues result in greater intelligibility. It is therefore highly likely that the technology would be of great benefit in devices for the hearing impaired such as hearing aids, cochlear implants, conversation amplifiers etc.

Stereo Unfold could also likely be applied in PA sound distribution systems to improve intelligibility for everyone in sonically difficult environments such as but not limited to train stations and airports. Stereo Unfold can offer benefits in all types of applications where the intelligibility of sound is of concern.

Stereo Unfold is just as appropriate in PA systems for sound reinforcement to enhance the intelligibility and sound quality of typically music and speech. It could be used in any type of live or playback performances in stadia, auditoria, conference venues, concert halls, churches, cinemas, outdoor concerts etc.

In addition to unfolding stereo sources in time the Stereo Unfold can be used to unfold mono sources similarly as it does stereo sources in time with psychoacoustic grouping to enhance the experience either from an intelligibility point of view or to provide improved playback performance in general.

The Stereo Unfold process is also not limited to a stereo playback system but could be used in any surround sound setup as well with processing, unfolding in time and grouping, occurring in the individual surround channels.

### SPECIFIC EMBODIMENTS OF THE PRESENT INVENTION

According to a first aspect of the present invention, there is provided a method for stereo reproduction in a loudspeaker system, said method comprising:
providing extracted information from the Left (L) and Right (R) stereo channels by utilizing DSP (digital signal processing); and
providing a number of new stereo channels with feeds (Fx) which are processed algorithms of the extracted information from the Left (L) and Right (R) stereo channels;
   wherein delay(s) (Dx) and/or frequency shaping(s) (Frx) are utilized in the processed algorithms;
   and wherein sound generated in the loudspeaker system is spread in at least two different directions.

According to one embodiment, delay(s) (Dx) are utilized in the processed algorithms. According to yet another embodiment, delay(s) (Dx) and frequency shaping(s) (Frx) are utilized in the processed algorithms. Furthermore, according to one embodiment, gain(s) (Gx) are also utilized in the processed algorithms. Moreover, frequency shaping(s) (Frx) may be utilized and the frequency shaping(s) (Frx) may predominantly limit the frequency range to above 50 Hz. Moreover, according to yet another specific embodiment, frequency shaping(s) (Frx) are utilized and the frequency shaping(s) (Frx) is performed so that the higher frequency contents are rolled of above 7 kHz. Moreover, frequency shaping(s) (Frx) may be utilized and the frequency shaping(s) (Frx) may be performed in a frequency range of from 100 Hz to 4 kHz.

According to yet another embodiment, delay(s) (Dx) are utilized and at least all except the two first delays D1 and D2 are at least 5 ms, such as in the range of 5-50 ms, e.g. in the range of 10-40 ms. Moreover, according to one embodiment the first two delays D1 and D2 are in the range of 0-3 ms.

According to yet another embodiment and related to a second aspect of the present invention which is linked to enhanced grouping, the method involves providing a number of unfolded feeds (Fx) as the processed algorithms of the extracted information from the Left (L) and Right (R) stereo channels. According to one embodiment in this direction, the method comprises psychoacoustic grouping at least one unfolded feed (Fx) with another one or more, and where the method also comprises playing back an unfolded and psychoacoustically grouped feed sound in the loudspeaker system. The number of unfolded feeds (Fx) may e.g. be at least 3, e.g. in the range of 3-30. Furthermore, one or more feeds (Fx) may be provided as a phase stabilizer. Moreover, according to yet another embodiment, the feeds (Fx) are psychoacoustically grouped by means of using multiple(s) of the fundamental(s). Moreover, several feeds (Fx) may be modified to have similar frequency contents.

According to a second aspect, the present invention is also directed to a loudspeaker system comprising at least one speaker, said loudspeaker system being arranged for
providing extracted information from the Left (L) and Right (R) stereo channels by utilizing DSP (digital signal processing); and
providing a number of new stereo channels with feeds (Fx) which are processed algorithms of the extracted information from the Left (L) and Right (R) stereo channels;
and wherein delay(s) (Dx) and/or frequency shaping(s) (Frx) are utilized in the processed algorithms,
   wherein said loudspeaker system is arranged to spread generated sound in at least two different directions; and wherein
   said loudspeaker system is a stereo unfold speaker system.

As may be understood from above, the present invention is directed to projecting the sound in at least two different directions. This may be accomplished by different means according to the present invention, both with only one speaker or several in the loudspeaker system. According to one specific embodiment of the present invention, the loudspeaker system only comprises one speaker. According to yet another embodiment, the system comprises at least two speakers, e.g. two speakers projecting sound in two different main directions. According to one specific embodiment, said at least two speakers, when viewed from a specific position, are facing at least two corresponding directions, and relative each other, being forward, left, right, up and to the back. All versions here are possible according to the present invention, such as three, four or even more speakers, facing in only two directions in total or in several different directions. All combinations thereof are possible according to the present invention. Furthermore, according to one embodiment, the loudspeaker system comprises one speaker per stereo channel. Also supporting speaker(s) are totally possible.

According to yet another aspect of the present invention, there is provided a loudspeaker system according to above and also providing enhanced grouping, said system also arranged to provide sound reproduction by a method comprising:
providing a number of unfolded feeds (Fx) which are the processed algorithms of the extracted information from the Left (L) and Right (R) stereo channels;
psychoacoustic grouping at least one unfolded feed (Fx) with another one or more; and
playing back an unfolded and psychoacoustically grouped feed sound in the loudspeaker system.

The above aspect implies that the system plays back both stereo information as well as grouped spatial information. Moreover, the loudspeaker system may comprise at least one additional driver in another direction than forward, as discussed above.

According to yet another aspect of the present invention there is provided a device arranged to provide sound reproduction with enhanced grouping by a method comprising:
providing a number of unfolded feeds (Fx) which are processed algorithms of sound signal(s);
psychoacoustic grouping at least one unfolded feed (Fx) with another one or more; and
playing back an unfolded and psychoacoustically grouped feed sound in a sound reproduction unit,
   wherein device is headphones or one or more speakers with drivers in a direct forward direction.

According to this aspect, when headphones are considered, Stereo Unfold processing creates a spatial 3D sound field with the headphones using the enhanced grouping process. As mentioned above, the direct and ambient sound fields are connected through enhanced grouping which moves the sound experience from the common within the listener's head to outside of the listener's head.

As said above, also in this case the number of unfolded feeds (Fx) may be at least 3, such as in the range of 3-30. Moreover, also in this case at least one additional speaker with a driver in another direction than forward may be implemented.

### 1. REFERENCES

[1] Barron, Michael “Auditorium Acoustics and Architectural Design” E&FN SPON 1993
[2] Albert S. Bregman, Auditory Scene Analysis The Perceptual Organization of Sound, 1994, ISBN 978-0-262-52195-6
[3] David Griesinger, The importance of the direct to reverberant ratio in the perception of distance, localization, clarity, and envelopment, Presented at the 122nd Convention of the Audio Engineering Society, 2007 May 5-8 Vienna, Austria
[4] David Griesinger, Perception of Concert Hall Acoustics in seats where the reflected energy is stronger than the direct energy, Presented at the 122nd Convention of the Audio Engineering Society 2007 May 5-8 Vienna, Austria
[5] David Griesinger, Pitch, Timbre, Source Separation and the Myths of Loudspeaker Imaging, Presented at the 132nd Convention of the Audio Engineering Society 2012 Apr. 26-29, Budapest, Hungary

1. Method for stereo reproduction in a loudspeaker system, said method comprising:
providing extracted information from the Left (L) and Right (R) stereo channels by utilizing DSP (digital signal processing); and
providing a number of new stereo channels with feeds (Fx) which are processed algorithms of the extracted information from the Left (L) and Right (R) stereo channels;
wherein delay(s) (Dx) and/or frequency shaping(s) (Frx) are utilized in the processed algorithms;
and wherein sound generated in the loudspeaker system is spread in at least two different directions.

2. Method according to claim 1, wherein delay(s) (Dx) are utilized in the processed algorithms.

3. Method according to claim 1, wherein delay(s) (Dx) and frequency shaping(s) (Frx) are utilized in the processed algorithms.

4. Method according to claim 1, wherein gain(s) (Gx) are also utilized in the processed algorithms.

5. Method according to claim 1, wherein frequency shaping(s) (Frx) are utilized and the frequency shaping(s) (Frx) predominantly limits the frequency range to above 50 Hz.

6. Method according to claim 1, wherein frequency shaping(s) (Frx) are utilized and the frequency shaping(s) (Frx) is performed so that the higher frequency contents are rolled of above 7 kHz

7. Method according to claim 1, wherein frequency shaping(s) (Frx) are utilized and the frequency shaping(s) (Frx) is performed in a frequency range of from 100 Hz to 4 kHz.

8. Method according to claim 1, wherein frequency shaping(s) (Frx) are utilized and the frequency shaping(s) (Frx) is performed in a frequency range of from 100 Hz to 4 kHz.

9. Method according to claim 1, wherein delay(s) (Dx) are utilized and at least all except the two first delays D1 and D2 are in the range of 5-50 ms.

10. Method according to claim 1, wherein delay(s) (Dx) are utilized and at least all except the two first delays D1 and D2 are in the range of 10-40 ms.

11. Method according to claim 1, wherein the first two delays D1 and D2 are in the range of 0-3 ms.

12. Method according to claim 1, wherein the method involves providing a number of unfolded feeds (Fx) as the processed algorithms of the extracted information from the Left (L) and Right (R) stereo channels.

13. Method according to claim 1, wherein the method comprises psychoacoustic grouping at least one unfolded feed (Fx) with another one or more, and wherein the method also comprises playing back an unfolded and psychoacoustically grouped feed sound in the loudspeaker system.

14. Method according to claim 1, wherein the number of unfolded feeds (Fx) is at least 3.

15. Method according to claim 1, wherein one or more feeds (Fx) are provided as a phase stabilizer.

16. Method according to claim 1, wherein the feeds (Fx) are psycho-acoustically grouped by means of using multiple(s) of the fundamental(s).

17. Method according to claim 1, wherein several feeds (Fx) are modified to have similar frequency contents.

18. Method according to claim 1, wherein the number of feeds (Fx) are in the range of 3-30.

19. Loudspeaker system comprising at least one speaker, said loudspeaker system being arranged for
providing extracted information from the Left (L) and Right (R) stereo channels by utilizing DSP (digital signal processing); and
providing a number of new stereo channels with feeds (Fx) which are processed algorithms of the extracted information from the Left (L) and Right (R) stereo channels;
and wherein delay(s) (Dx) and/or frequency shaping(s) (Frx) are utilized in the processed algorithms,
wherein said loudspeaker system is arranged to spread generated sound in at least two different directions; and wherein
said loudspeaker system is a stereo unfold speaker system.

20. Loudspeaker system according to claim 19, wherein said loudspeaker system has at least two speakers projecting sound in two different main directions.

21. Loudspeaker system according to claim 20, wherein said at least two speakers, when viewed from a specific position, are facing at least in two corresponding directions, and relative each other, being forward, left, right, up and to the back.

22. Loudspeaker system according to claim 19, wherein the loudspeaker system comprises one speaker per stereo channel.

23. Loudspeaker system according to claim 19, wherein the loudspeaker system comprises also supporting speaker(s).

24. Loudspeaker system according to claim 19, also arranged to provide sound reproduction by a method comprising:
providing a number of unfolded feeds (Fx) which are the processed algorithms of the extracted information from the Left (L) and Right (R) stereo channels;
psychoacoustic grouping at least one unfolded feed (Fx) with another one or more; and
playing back an unfolded and psychoacoustically grouped feed sound in the loudspeaker system.

25. Loudspeaker system according to claim 24, also comprising at least one additional driver in another direction than forward.

26. Device arranged to provide sound reproduction by a method comprising:
providing a number of unfolded feeds (Fx) which are processed algorithms of sound signal(s);
psychoacoustic grouping at least one unfolded feed (Fx) with another one or more; and
playing back an unfolded and psychoacoustically grouped feed sound in a sound reproduction unit,
wherein device is headphones or one or more speakers with drivers in a direct forward direction.

27. Device according to claim 26, wherein the number of unfolded feeds (Fx) are at least 3.

28. System comprising a device according to claim 26 and also at least one additional speaker with a driver in another direction than forward.
